(19) United States
(12) Patent Application Publication
(10) Pub. No.: US 2005/0183975 A1
(43) Pub. Date: Aug. 25, 2005

(54) Transport cover for the disposal of Christmas trees

(76) Inventor: Axel Stein, Rosbach (DE)

Correspondence Address: COLLARD & ROE, P.C., 1077 Northern Boulevard, Roslyn, NY, 11576, US

(21) Appl. No.: 11/039,317

(22) Filed: Jan. 19, 2005

(30) Foreign Application Priority Data
Feb. 11, 2004 (DE) 20 2004 002 013.0

(51) Int. Cl. B65D 85/50; A01G 13/02

(52) U.S. Cl. 206/423

(57) ABSTRACT

A transport cover for the disposal of Christmas trees is shown wherein the cover is comprised of a flexible cylindrical tube made of film, fabric or similar material and is adapted to be closed at its ends with ropes or strings drawn around the cover.

### TECHNICAL FIELD

This invention relates to a transport cover for the disposal of Christmas trees.

### BACKGROUND OF THE INVENTION

When Christmas trees are disposed of, falling needles cause considerable soiling and hence extravagant cleaning work in apartments and stairways. The obvious idea of packing the old Christmas tree for transportation in such a way that it can lose no needles en route has already led to a number of utility model applications (DE 297 17 614 U1, DE 200 09 807 U1, G 84 14 708.3 U1, DE 299 21 739 U1) but none has been marketed to date. This is owed to the fact that all the solutions proposed in the past were too elaborate and hence too expensive in production, too complicated in use, or unsuitable in their adaptability, e.g., for various sizes of tree.

### SUMMARY OF THE INVENTION

It is an object of the present invention to provide a transport cover for the disposal of Christmas trees which is easy to handle and can be manufactured with minimum possible expenditure. The transport cover should be reusable and suitable for trees of different size. Nevertheless it should be possible to offer the cover in two or three sizes. It should be possible to fit the cover where the Christmas tree stands and while the tree is still held in its stand. The cover should be made of a tear-resistant material. Alternatively, the same design can also be used for the manufacture of disposable covers if a biodegradable material is employed.

The transport cover should be a single-piece construction, preferably a cylindrical tube or a conical shell development, in each case without a bottom. For easier use provision can be made for a re-closable separation: a zipper closure, a hook-and-loop fastener or the like, and adhesive areas for the disposable cover. Ropes are used to close the open end.

### BRIEF DESCRIPTION OF THE DRAWING

The invention will be explained in more detail in the following with reference to embodiments shown in the accompanying drawing.

### DETAILED DESCRIPTION OF THE INVENTION

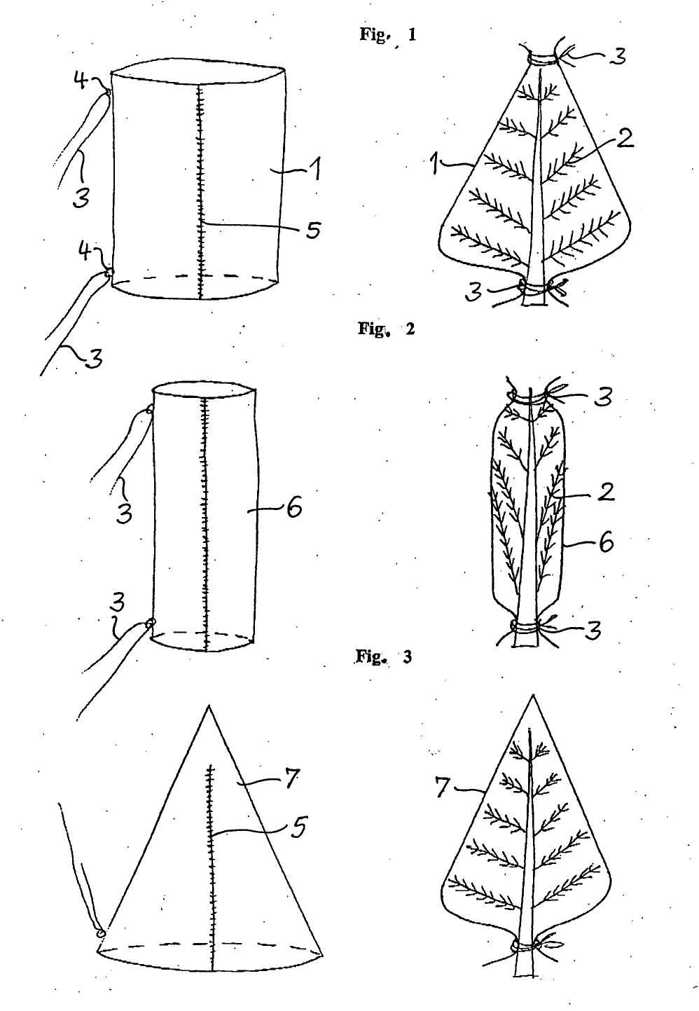

In the embodiment shown in FIG. 1 the cover 1 is comprised of an essentially cylindrical tube section whose diameter equals the biggest diameter of the trees to be packed. The cover 1, gathered together into a ring, can be placed over the tree 2 and then pulled apart in upward and downward direction, or it can first be closed at the top and then be pulled over the tree from the top. At the top and under the branches the cover 1 is drawn together with ropes 3. The ropes 3 can be threaded through eyelets 4, be drawn through seams or be supplied loose. The cover 1 can be separated once in longitudinal direction and be re-closable by means of a closure 5, e.g., a zipper closure, a hook-and-loop fastener or the like, which makes it far easier to handle the cover.

The cover 6 of the embodiment of FIG. 2 is comprised of a tube section similar to FIG. 1 but with a smaller diameter than the diameter of the tree 2 to be packed in order for the dimensions of the tree 2 to be substantially reduced for transportation at the same time as it is packed. Here, too, a re-closable separation is suitably provided in order not to have to lift the tree 2 to fit the cover 6. The cover 6 is placed around the trunk under the branches and closed if required. The cover 6, gathered together, forms a stable ring which, when pulled upward, presses the branches against the trunk and covers them. Also in this embodiment the cover 6 is closed at the top and bottom with ropes 3 or the like.

FIG. 3 shows a cover 7 which is comprised of a conical shell without a bottom, the shell conforming ideally to the shape of a tree. The projecting length at the foot of the cone is used to close the cover 7 and can be dimensioned large enough to fit all Christmas trees. However, it is recommended to offer two or three sizes in this case as well. Fitting the cover 7 is greatly simplified in this embodiment too by a separable and, using a closure 5, re-closable opening which extends from the top to the bottom.

1. A transport cover for the disposal of Christmas trees wherein the cover is comprised of a flexible cylindrical tube made of film, fabric or similar material and is adapted to be closed at its ends with ropes or strings drawn around the cover.

2. A transport cover according to claim 1 wherein the cover is separated in longitudinal direction, said separation being equipped with a closure, in particular a zipper closure, a hook-and-loop fastener or an adhesive closure.

3. A transport cover according to claim 2 wherein the diameter of the cover is smaller than the largest outer diameter of the tree.

4. A transport cover according to claim 1, wherein it is comprised of a bio-degradable material.

5. A transport cover for the disposal of Christmas trees wherein the cover is comprised of a flexible, conical shell with an open bottom, the shell being made of film, fabric or similar material and adapted to be closed at its foot end with a rope or string drawn around the cover.

6. A transport cover according to claim 5 wherein the conical shell is separated from one point at the tip region to the foot end, said separation being adapted to be closed with a closure, in particular a zipper closure, a hook-and-loop fastener or an adhesive closure.

7. A transport cover according to claim 5, wherein it is comprised of a bio-degradable material.

8. A transport cover for the disposal of objects comprising:
a flexible cylindrical tube made of film, fabric or similar material; and
a plurality of ropes or strings for closing said tube at its ends with said ropes or strings drawn around the cover.
